(19) United States
(12) Patent Application Publication
(10) Pub. No.: US 2011/0094629 A1
(43) Pub. Date: Apr. 28, 2011

(54) PROCESSES FOR IN-SITU COATING OF METALS

(76) Inventors: Zhigang Zak Fang, Salt Lake City, UT (US); Hong Yong Sohn, Salt Lake City, UT (US); Peng Fan, Salt Lake City, UT (US); Eric Riddle, Centerville, UT (US)

(21) Appl. No.: 12/811,069

(22) PCT Filed: Dec. 31, 2008
(86) PCT No.: PCT/US08/88652

§ 371 Date: Jan. 6, 2011

Related U.S. Application Data
(60) Provisional application No. 61/018,162, filed on Dec. 31, 2007.

(51) Int. Cl. C23C 26/00; B32B 15/00

(52) U.S. Cl. 148/241; 148/400

(57) ABSTRACT

Processes for coating metal surfaces are disclosed and described. Applying a metal powder (24) to a metal substrate (12) under plasma transferred arc conditions can promote in-situ reaction between these materials. A substantially nonporous intermetallic alloy coating (28) can be formed in this manner and is particularly suited to Fe, Ni, and Co based intermetallic alloys.

### BACKGROUND OF THE INVENTION

In many high-temperature industrial applications, both high-temperature strength and high-temperature corrosion-resistance are required. However, it is usually very difficult to develop steels and alloys that can satisfy both high temperature strength and corrosion resistance requirements. Therefore, applying a high-temperature corrosion-resistant coating on a base alloy that has superior high temperature strength is a both technically and economically attractive approach for these applications.

Iron aluminide exhibits many properties that are desirable in a high-temperature corrosion-resistant coating material. In general, iron aluminide has superior resistance to oxidation and sulfidation at high temperatures. It also exhibits other generally desired attributes such as low density, good wear resistance, and low cost. However, the industrial applications of iron aluminide as bulk components have been very limited because of the low ductility of iron aluminide materials which poses considerable technical challenges for fabricating bulk components of this material.

Iron aluminide coatings have been explored with various coating processes, including a) chemical vapor deposition (CVD) processes, best for producing thin coatings; and b) thermal spray processes for making thicker coatings. However, for many industrial structure applications thick coatings are often necessary considering the severe environments of high-temperature corrosion and erosion and the required long service lifetime. Therefore, various thermal spray processes are often the only viable options for making thick coatings needed for such applications. However, even with the better thermal spray processes, iron aluminide coatings with sufficient density are still difficult to obtain. Furthermore, the mechanical bonding between the coating and substrate is often unsatisfactory for demanding applications. Therefore, a need still exists for dense high-strength coatings and methods for effectively forming such coatings.

### SUMMARY OF THE INVENTION

The present invention provides processes for coating metal substrates. A general embodiment of this process comprises the steps of (a) introducing a gas between an electrode and a metal substrate that are connected through a DC power source; (b) establishing a voltage between the electrode and the metal substrate sufficient to create from the gas a plasma arc that extends between the electrode and the metal substrate, so that the plasma arc heats a zone of the metal substrate; and (c) injecting a metal powder into the plasma arc and adjacent to the zone, so that the metal powder is heated sufficiently to react with the metal substrate and create an intermetallic alloy coating in the zone. By this process a substantially phase-pure metallurgical bond can be created between the intermetallic alloy coating and the metal substrate.

In one aspect of the invention the metal substrate can comprise or consist essentially of iron, although in an alternative aspect the metal substrate can comprise or consist essentially of nickel. In a specific embodiment, the metal powder includes or consists of aluminum and iron, or aluminum and nickel. In a particular aspect of this embodiment, aluminum is present in the metal powder in an amount of about 25 at % to about 100 at %. In a more particular aspect, aluminum is present in the metal powder in an amount from about 50 at % to about 100 at %. In a still more particular aspect, aluminum is present in the metal powder in an amount from about 75 at % to about 100 at %.

In another aspect of the general embodiment, the gas includes hydrogen in an amount from about 1 vol % to about 10 vol %. Such hydrogen gas is optional and not necessary when the process is performed in a protected chamber, i.e. air and oxygen are substantially excluded from the environment. In still another aspect of a small embodiment, the plasma arc has a current from about 40 A to about 80 A. In a more specific aspect, the plasma arc has a current from about 60 A to about 70 A. These currents can vary considerably based on the size of the plasma system used.

In one particular embodiment of the invention, the intermetallic alloy coating created by the process is substantially non-porous. In another embodiment, heat is generated when the metal powder reacts with the metal substrate, which heat promotes formation of the intermetallic alloy coating.

The present invention also provides an intermetallic coating for a metal substrate formed by a process comprising the steps of (a) introducing a gas between an electrode and a metal substrate that are connected through a DC power source; (b) establishing a voltage between the electrode and the metal substrate sufficient to create from the gas a plasma arc that extends between the electrode and the metal substrate, so that the plasma arc heats a zone of the metal substrate; and (c) injecting a metal powder into the plasma arc and adjacent to the zone, so that the metal powder is heated sufficiently to react with the metal substrate and create an intermetallic alloy coating in the zone. The intermetallic alloy coating exhibits a substantially metallurgical bond with the metal substrate, and the intermetallic alloy coating is substantially free from porosities. In some embodiments, the intermetallic alloy can be substantially phase pure.

In a particular aspect, the metal substrate comprises steel. In an alternative aspect, the metal substrate comprises nickel or nickel-based alloy. In another particular aspect, the metal powder includes aluminum.

In another aspect of the general embodiment, the intermetallic coating has a thickness of from about 0.05 mm to about 5 mm. In a more particular aspect, the intermetallic coating has a thickness of from about 0.5 mm to about 3 mm. In still another aspect of the general embodiment the intermetallic coating and interface are substantially non-porous.

In particular, using iron aluminide as coatings in high temperature applications has been recognized as desirable to take advantages of its superior high-temperature corrosion-resistance while avoiding the challenges of fabricating bulk components by using the processes of the present invention. Iron aluminide coating is especially attractive for power generation industry which has been making great efforts to increase the efficiency of coal-fired boilers by increasing the operating temperature and steam pressure, thus requiring better corrosion resistance.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a side view cross-sectional view of a plasma transferred arc welding assembly electrically connected to a metal substrate workpiece in accordance with one embodiment of the invention.

FIG. 2 is a graph of iron and aluminum content as a function of position in an iron aluminide coating applied to a steel substrate using pre-alloyed iron aluminide powder as the feed material in accordance with one embodiment of the invention.

FIG. 3 is a graph of iron and aluminum content as a function of position in an iron aluminide coating applied using a mixture of iron and aluminum powders as the feed material in accordance with another embodiment of the invention.

FIGS. 4A and 4B are SEM graphs of iron aluminide coatings in accordance with embodiments of the present invention.

FIG. 5 is a graph of aluminum content as a function of position in an iron aluminide coating applied using pure aluminum powder as the feed material, using five different plasma currents in accordance with another embodiment of the invention.

FIG. 6 shows a graph of aluminum content of a series of iron aluminide coatings, applied using pure aluminum powder as the feed material, plotted against plasma currents employed in accordance with one embodiment of the invention.

FIG. 7 shows a graph of an X-ray diffraction analysis of the iron aluminide coating applied using pure aluminum powder as the feed material and obtained at plasma current of 60 A in accordance with one embodiment of the invention.

Reference will now be made to the exemplary embodiments illustrated, and specific language will be used herein to describe the same. It will nevertheless be understood that no limitation of the scope of the invention is thereby intended.

### DETAILED DESCRIPTION OF THE INVENTION

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

### DEFINITIONS

In describing and claiming the present invention, the following terminology will be used:

The singular forms “a,” “an,” and “the” include plural referents unless the context clearly dictates otherwise.

As used herein, the term “intermetallic alloy” refers to a solid phase material that is a homogeneous solid solution phase of two or more metals and is a product of a reaction between those metals. Typically the intermetallic alloy exhibits properties different than each of the constituent metals alone.

As used herein, “non-porous” and “free of porosities” refers to a porosity which is sufficiently low to prevent polyatomic gas from passing through without being dissociated, e.g. less than about 1.0 vol %.

As used herein, “iron aluminide” includes various phases of iron-aluminum alloys including Fe₃Al, FeAl, etc. In some cases, the iron aluminide of the present invention can be phase pure, i.e. substantially a single phase such as Fe₃Al, although other phases are sometimes present.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Thicknesses, weight percentages, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 0.01 to 2.0 mm” should be interpreted to include not only the explicitly recited values of about 0.01 mm to about 2.0 mm, but also include individual values and sub-ranges within the indicated range. Thus, included in this numerical range are individual values such as 0.5, 0.7, and 1.5, and sub-ranges such as from 0.5 to 1.7, 0.7 to 1.5, and from 1.0 to 1.5, etc. This same principle applies to ranges reciting only one numerical value. Furthermore, such an interpretation should apply regardless of the breadth of the range or the characteristics being described.

### Embodiments of the Invention

A number of industrial applications require the use of materials that can withstand high-temperatures and corrosive conditions. For example, in applications involving coal-fired power plant boilers, it has become increasingly important to use materials which have the combined qualities of adequate creep strength, thermal fatigue resistance, and corrosion resistance, due to the components being subject to extremely high temperatures and stresses. Furthermore, recent advances made in coal power plant technology have increased the efficiency of boiler operations by raising the steam temperatures up to 760° C. and pressures up to 30 MPa. A long term industry goal is to achieve operation at more than 870° C. Unfortunately, the steel alloys used today are not capable of performing well at these elevated temperatures, and the development of a satisfactory material is critical to meeting the demands of future systems.

Intermetallic alloys are a unique class of candidate materials for high-temperature corrosion resistant applications. Examples of such intermetallic alloys include aluminides such as such as iron aluminide and nickel aluminide. Iron aluminide is one favorable candidate as a high-temperature corrosion-resistant coating material. In general, iron aluminide has superior resistance to oxidation and sulfidation at high temperatures. It also exhibits other generally desired attributes such as low density, good wear resistance, and low cost. However, the industrial applications of iron aluminide as bulk components have been very limited because of the low ductility of iron aluminide materials, which poses considerable technical challenges for fabricating bulk components from this material. Using iron aluminide as a coating in high temperature applications can take advantage of its superior high-temperature corrosion-resistance while avoiding the challenges associated with bulk component fabrication. Iron aluminide coating is especially attractive for power generation industry which has been making great efforts to increase the efficiency of coal-fired boilers by increasing the operating temperature and steam pressure, thus requiring better corrosion resistance.

Intermetallic coatings have been explored with various coating processes, among which two categories of processes are notable: a) reaction coating processes including conventional chemical vapor deposition (CVD) processes, fluidized bed reactor CVD (FBR-CVD), and pack cementation processes, for producing thin coatings with thicknesses typically less than 20 μm; and b) thermal spray processes for making thick coatings with thicknesses from 0.5 to 3.0 mm. For many industrial structure applications, including coal-fired power generation, thick coatings are often necessary considering the severe environments of high-temperature corrosion and erosion and the required long service lifetime. Therefore, thermal spray processes have been typically viewed as the only viable options for making thick coatings of intermetallics such as iron aluminide.

Many thermal spray coating techniques, such as arc spray, low pressure plasma spray, air plasma spray and high velocity oxyfuel (HVOF) spray, have been explored for depositing thick powder-based intermetallic coatings on various steel substrates. However, coatings with full density can be difficult to obtain with such HVOF processes. For example, unacceptably high porosity and oxide inclusions are often found in aluminide coatings produced by HVOF. Furthermore, the mechanical bonding between HVOF aluminide coatings and substrates is often unsatisfactory for demanding applications and can result in delamination or failure of the coating.

In an embodiment of the present invention, intermetallic coatings are applied using a unique coating technique, i.e. the plasma transferred arc (PTA) process. In a particular embodiment of the present invention, the coating may be an aluminide. In a more particular embodiment, the coating may be an aluminide alloy of iron or of nickel. While the description herein of exemplary embodiments may refer primarily to iron aluminide for purposes of illustration, these are to be understood to also be applicable to nickel aluminide or other suitable intermetallics absent an express statement to the contrary. For example, generally, the intermetallic alloy coating can comprise M_{w}CrₓAl_{y}X_{z}, where M is Fe, Ni, or Co; X is a transition metal; w is from 1 to 5; x is 0 to 5; y is 0 or 1 wherein both x and y cannot be zero; and z is an integer from 0 to 3. When M is Fe, the intermetallic alloy coating can typically primarily comprise Fe₃Al, FeAl, Fe_{w}Al where w is ⅘ to 4, and combinations of these alloys. In the case when M is Ni, the intermetallic alloy coating can typically primarily comprise Ni₃Al, NiAl, Ni_{w}Al where w is ⅔ to 4, and combinations of these alloys. Other representative intermetallic alloy coatings can include FeCrAl, NiCr, CoCr, combinations thereof, and the like. Furthermore, transition metals such as Y, Hf, Ce, Zr, Ti, or Ta can also be incorporated into the coatings of the present invention by providing a corresponding powder source. Although not always required, the intermetallic alloy coating can often consist essentially of the M_{w}CrₓAl_{y}X_{z} class of alloys.

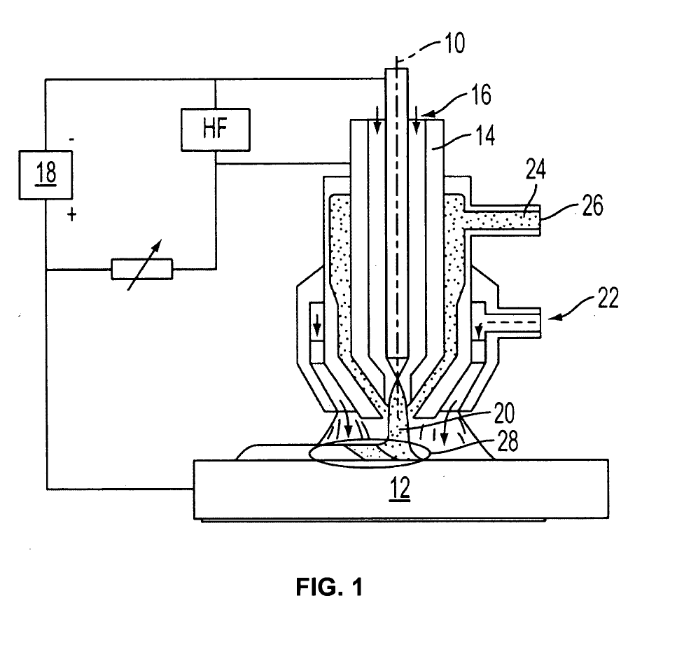

In the PTA process, a coating is formed on a substrate by an in-situ reaction between the metal powder that is applied through a plasma torch and a substrate material. FIG. 1 shows a diagram of a PTA apparatus 100 that can be used in accordance with the present invention. The PTA process involves creating a plasma arc between a non-consumable electrode 10 and a metal substrate 12 to be coated. In one specific embodiment, the electrode may be a tungsten electrode. The apparatus can include a nozzle 14 in which a plasma is formed by ionizing a plasma gas 16 flowing within the nozzle. The electrode is generally recessed within the nozzle and therefore concentrically surrounded by the plasma gas. A DC power source 18 can be connected to the electrode and the metal substrate. Typically, this power source can also be variably adjustable in order to control current and thus deposition properties. Applying a sufficient voltage between the electrode and the substrate heats and ionizes the plasma gas, creating a charged plasma 20 that exits the nozzle and impacts the substrate. In most instances, the nozzle exhibits a constricting orifice which focuses and imparts a higher velocity to the plasma, thereby producing a high concentration of heat. The plasma beam may be surrounded by a shielding gas 22 to prevent unwanted oxidation due to oxygen entering the heated zone. Inert gases may be used for the shielding gas, such as argon or helium, or also mixtures that include such gases, e.g. an argon/hydrogen mixture.

The highly conductive plasma completes an electrical circuit together with the metal substrate, the DC power source, and the electrode. As such, PTA is an arc welding process that uses plasma to transfer an electric arc to a workpiece. The intense heat provided by the plasma arc can be used to fuse metal constituents together. In plasma transferred arc processes, a feed material can be introduced into the arc and fused to a workpiece. In the present method, the feed material is a metal powder 24 which is fed into the nozzle, and ejected with the plasma onto to the substrate. In a specific aspect, a carrier gas 26 is used to carry the metal powder into the apparatus. Argon gas may be used for the plasma gas and the carrier gas, as well as the main component in the shielding gas, although other inert gases can also be used.

The metal powder used in the process may depend on the metal substrate to be coated. In a conventional welding process, the feed material may simply be deposited on the substrate. In such cases the heat generated by the process may melt the feed material enough so that the feed material forms a coating on the substrate. However, this coating may still remain metallurgically distinct from the substrate. As a result, the phase boundary between the coating and the substrate may be characterized by high porosity or oxide inclusions, resulting in less than durable coating. These effects can also be attendant to other coating methods mentioned above, including CVD and HVOF. In the present method, however, the coating arises from a chemical reaction between the coating material and the surface of the substrate. More particularly, a metal powder is used that can react with the metal of the substrate. This powder is injected into the plasma arc generated in the PTA process, where the powder is melted. The melted powder is deposited onto the substrate and reacts with the substrate to form an intermetallic coating on the substrate.

In a particular embodiment, the substrate may be any structure having an exposed surface and comprising a base metal such as iron, nickel or cobalt. In a more particular embodiment, the substrate to be coated is iron or steel. In another particular embodiment, the substrate to be coated comprises nickel or a nickel-based alloy. Non-limiting examples of commercial substrate materials can include ferritic steels such as HCM12, austenitic steel such as 304, and nickel alloys such as Inconel 600. The substrate can be optionally heated to a temperature sufficient to form a thin molten layer on the exposed surface of the metal substrate, e.g. a substrate “sweat” layer. This thin molten layer can then more intimately mix and/or diffuse into the formed intermetallic alloy coating.

Aluminum powder may be used to coat either of these substrate metals, and thereby create an iron aluminide or a nickel aluminide coating, respectively. It has been found that blended powders may also be used as a feed material in the present process. Accordingly, in an aspect of the aluminide embodiments, aluminum is present in the metal powder in an amount of at least about 25 at % and mixed with powder having either a common element or same composition as the substrate. In a more particular aspect, aluminum is present in such a blend in an amount from about 50 at % to about 100 at %. In a still more particular aspect, aluminum is present in such a blend in an amount from about 75 at % to about 100 at %. The resultant coating composition is dependent on many factors including feed compositions, feeding rate, plasma power, substrate cooling, etc. It should be noted that other useful substrate/feed combinations may be produced by the present methods and according to the same general principles. Some non-limiting examples include making nickel aluminide coatings on Ni or Ni-based alloy substrates by using Al powder as the feed material; FeCrAl coatings on steel substrates by using elemental powder mixture of Al and Cr; or FeAl coatings on steel or iron substrates by using Al powder as a feed material.

Although particle size can vary, typical feed particle sizes can range from about 20 μm to about 1000 μm, and often from about 40 to about 500 μm. The carrier gas can be provided in a sufficient volume to carry the particles to the exit point of the nozzle 14 while minimizing plugging at one extreme and/or excessive dilution at the other.

One advantage of the PTA process in comparison with other thermal spray processes is that the substrate is part of the power circuit, producing intense localized heat in a zone 28 of the substrate. A result is that the substrate surface and the feed powder can be heated to their melting temperatures during welding. In an aspect of the PTA process, the coating layer is substantially or completely melted during the process. Porosities and oxide inclusions in the coating can thereby be kept to minimum, resulting in a dense interface between the coating and the substrate. In another aspect, the interface is substantially free from porosities.

As discussed above, another advantage of the present process also arises in part from the in-situ chemical reaction that occurs between the coating material and the substrate. In such a reaction, the substrate offers at least part of a constituent for the coating. The substrate material can be contributed to the coating by melting of the substrate and/or diffusion of substrate atoms into the coating during the PTA process. As a result, a metallurgical bond is created between the materials that can be stronger than coatings from conventional plasma arc processes, in which solid powders of the coating materials are fed through the torch and welded on the substrate. In addition, intermetallic reactions produced by the methods of the present invention tend to be exothermic. Therefore the heat created by the reaction can also contribute to the overall heat in the welding zone in promoting alloy formation.

It is also very feasible to obtain coatings with thicknesses of a few millimeters with the present process, as opposed to PVD or CVD coatings which are typically in the μm range. In a particular aspect, the intermetallic coating can have a thickness of from about 0.05 mm to about 5 mm. In a more particular aspect, the intermetallic coating has a thickness of from about 0.5 mm to about 3 mm.

The elemental powders, the substrate surface and the resultant coating layer can be in a liquid state for at least a small period of time during the coating process, so that the in-situ reaction or alloying process can be completed to form uniform coatings. Otherwise, the unreacted elemental powders will be included in the coating layers, resulting in coatings of low quality (although such may be acceptable for some applications). Therefore, sufficiently high heat flux towards the substrate surface is necessary for the success of in-situ reaction coating process. In this respect, the PTA technique is more suitable than other thermal spray techniques, because PTA torch is designed to offer heat flux towards the substrate high enough for the substrate surface to be melted, while in other thermal processes the torch is designed to operate for a “cold” (in relationship to the melting point of the substrate material) substrate surface and thus no surface melting can occur to supply constituents for coatings. An unexpected aspect of the present process is that dilution from the substrate, which is usually inevitable in a PTA process and in many cases thought of as one of the disadvantages for PTA in comparison with other thermal spray techniques, actually contributes to the effectiveness of the in-situ reaction coating process.

### EXAMPLES

### Example 1

### Coatings with Iron Aluminide Powder as Feed Material

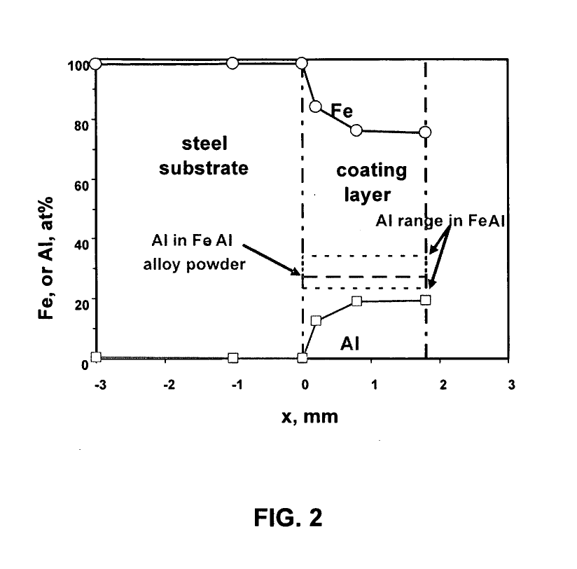

A conventional PTA process was tested in which iron aluminide powder (commercially acquired) was used as feeding material. In the process, the plasma voltage was fixed to be 40 V by the PTA equipment used (Starweld® Microstar 150, Deloro Stellite Group), while the plasma currents chosen for different runs varied as 20, 40, and 60 A. The distance between the plasma torch and the substrate was less than 12 mm to prevent the plasma from dying off. Optical microscopy indicated that the coatings obtained with low plasma currents (20 or 40 A) had a lot of porosity inside the coating layers and at the coating/substrate interfaces, resulting in the bonding strength between the coatings and the substrates so poor that the coatings would delaminate from the substrates during sample sectioning for metallographic observation or even during cooling down after coating process in some cases. As the plasma current increased to 60 A, coatings with little porosity and excellent bonding strength between the coating and the substrate were obtained. FIG. 2 depicts the variation profiles of aluminum and iron contents across the coating layer obtained at the plasma current of 60 A.

The iron aluminide powder, acquired from Ametek Specialty Metals, had composition of 15.4 wt % Al, 5.8 wt % Cr and Fe as balance and a powder size of 44-149 μm. The aluminum content in the original iron aluminide powder used in the test was Al=27.27 atom %, while the maximum Al content in the resultant coating was 19.46 atom % that is 71.4% of original Al content in iron aluminide powder, clearly demonstrating the significant dilution from the steel substrate. Higher plasma current, in other words, higher plasma heat input, which will increase the melting of substrate surface and thus the dilution, should generally be avoided. Lower plasma current is expected to lessen the dilution problem but increase the porosity and decrease the coating-substrate bonding strength. To overcome these contradicting factors, a relatively high plasma current can be used to ensure good bonding and low porosity, while increasing the aluminum content in the feed powder to compensate for the inevitable dilution.

### Example 2

### Coatings with Mixture of Iron Powder and Aluminum Powder as Feed Material

The process of Example 1 was employed using a mixture of iron powder and aluminum powder (Al/(Fe+Al)=25 atom % in corresponding to Fe₃Al) as feeding materials and a plasma voltage of 40 V and plasma current of 60 A. The constituent powders were electrolytic iron powder (>99 wt % Fe) having a size<149 μm size and aluminum powder (>99.8 wt % Al) of 44-420 μm size. The substrates used were plain low-carbon steel coupons of 12.7 mm thickness, 38.1 mm width and 76.2 mm length.

In the first few runs, pure argon was used as carrier gas, plasma gas and shielding gas, as was done for coating tests with iron aluminide powder as feeding materials. However, it was found that dense coatings could not be produced, which was attributed to the significant oxidation of aluminum powder and/or iron powder before these two powders melted and reacted with each other to form iron aluminide coatings on the steel substrates, since the oxidized surfaces of aluminum powder and/or iron powder would prevent not only the wetting and reaction between the two powders but also the adhering of them to the substrate. Therefore, a small amount of hydrogen was added in the argon to provide protection from oxidation, and experiments indicated that the argon/hydrogen mixture gas with 5 vol % of H₂ was suitable to obtain dense coatings.

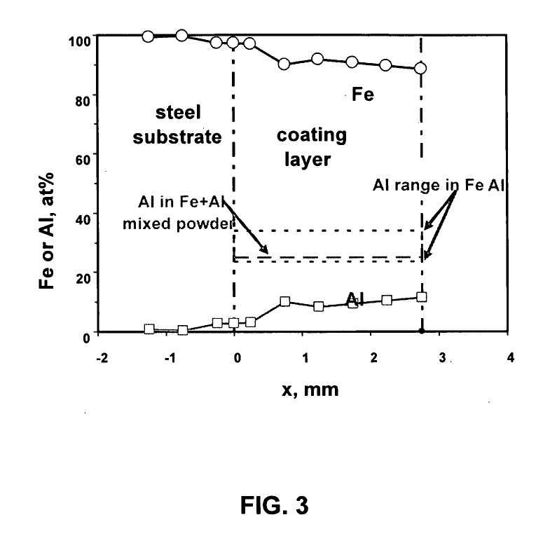

The profile of aluminum content across the coating layer, obtained at plasma voltage of 40 V and plasma current of 60 A, was plotted in FIG. 3. The original aluminum content in the mixture of iron powder and aluminum powder was 25 atom %, but the maximum Al content in the resultant coating was just 11.58 atom %, indicating even more severe dilution from steel substrate than that with iron aluminide powder.

### Example 3

### Coatings with Aluminum Powder as Feed Material

The process of Example 1 was employed using pure aluminum powder as the feed material, the mixture gas of argon and hydrogen with 5 vol % H₂ in the mixture was used as the carrier gas, plasma gas and shielding gas. The plasma voltage was fixed to be 40 V, while the plasma currents were 20, 30, 40, 50, 60, 70, 75 and 80 A, respectively, in different test runs.

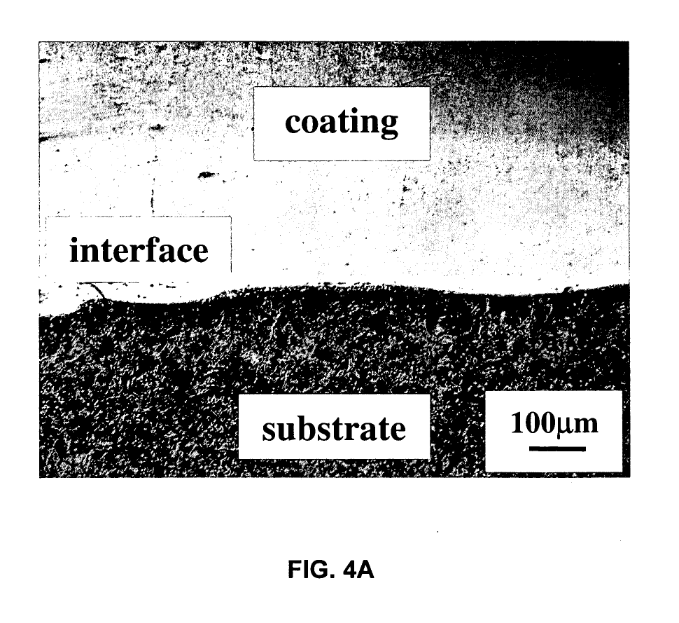

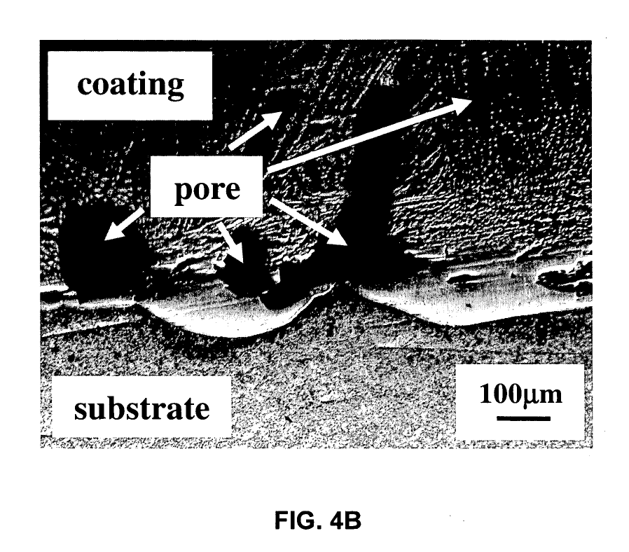

It was found that when plasma currents were 50 A or higher, continuous coating layers were formed and excellent metallurgical bonding formed between the coating and the substrate, as shown in FIG. 4A. If plasma current were 40 A or lower, there were significant amounts of pores in the coating layers, as shown in FIG. 4B, indicating probably insufficient melting of Al powder or insufficient Fe/Al reaction due to lower heat input.

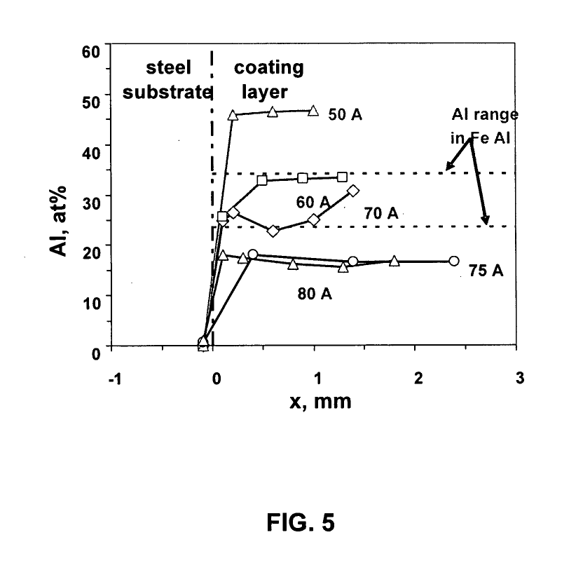

Compositional analysis across coating layers obtained at 50 A or higher plasma currents, as shown in FIG. 5, suggests that the compositions in the obtained coatings are quite uniform.

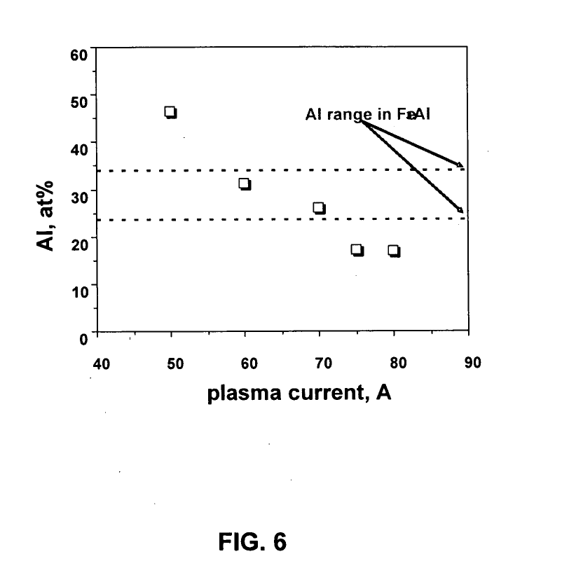

A plot of Al content versus the employed plasma current, shown in FIG. 6, indicates that 60 to 70 A are suitable plasma currents to be used for iron aluminide coating through using mere Al powder, because the composition of coatings thus obtained was within the Al content range of iron aluminide. At plasma currents of higher than 70 A, Al contents in the resultant coatings were lower than that of Fe₃Al due to the excessive dilution from the substrate. At plasma currents of lower than 60 A, the supply of iron from the steel substrate was not sufficient to react with Al feed to form iron aluminide coatings.

It is worth pointing out that a suitable plasma current depends on the ratio between the feeding rate of aluminum powder and the supply rate of melted iron from the substrate surface that in turn is dependent on heat transferred into and dissipated from the substrate surface. Therefore, it is expected that suitable plasma current will increase with enhancing cooling accompanied by using forced cooling under the substrate.

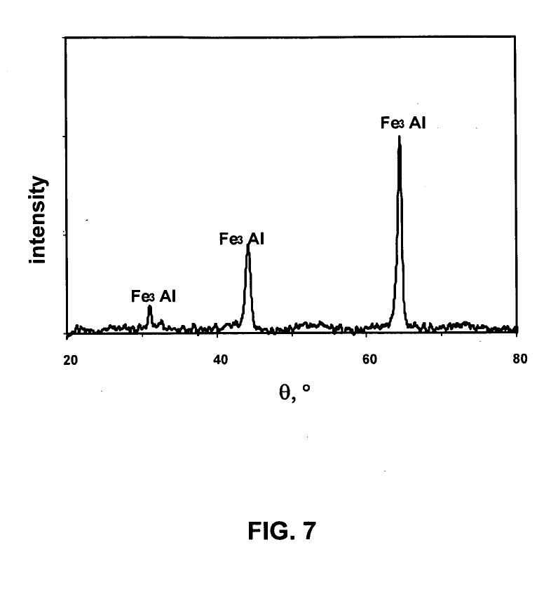

X-ray diffraction analysis of the coatings obtained at 60 A, shown in FIG. 7, further verified that the coatings consisted essentially of iron aluminide phase without noticeable existence of other impurity phases.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A process for coating a metal substrate, comprising:
(a) introducing a plasma gas between an electrode and a metal substrate, wherein the electrode and the metal substrate are connected through a DC power source;
(b) establishing a voltage between the electrode and the metal substrate sufficient to create from the plasma gas a plasma arc extending between the electrode and the metal substrate, so that said plasma arc heats a zone of the metal substrate; and
(c) injecting a metal powder into the plasma arc adjacent to the zone, so that the metal powder is heated sufficiently to react with the metal substrate and create an intermetallic alloy coating in the zone,
wherein a substantially metallurgical bond is created between the intermetallic alloy coating and the metal substrate.

2. The process of claim 1, wherein the metal substrate comprises iron or steel.

3. The process of claim 1, wherein the metal substrate comprises nickel or nickel-based alloy.

4. The process of claim 1, wherein the metal powder includes aluminum.

5. The process of claim 4, wherein aluminum is present in the metal powder in an amount of at least about 25 at % mixed with powder having either a common element or same composition as the substrate.

6. The process of claim 5, wherein aluminum is present in the metal powder in an amount from about 50 at % to about 100 at % mixed with powder having either a common element or same composition as the substrate.

7. The process of claim 6, wherein aluminum is present in the metal powder in an amount from about 75 at % to about 100 at % mixed with powder having either a common element or same composition as the substrate.

8. The process of claim 1, wherein the intermetallic alloy coating is substantially non-porous.

9. The process of claim 1, wherein the intermetallic alloy coating comprises M_{w}CrₓAl_{y}X_{z}, where M is Fe, Ni, or Co; X is a transition metal; w is from 1 to 5; x is 0 to 5; y is 0 or 1 wherein both x and y cannot be zero; and z is an integer from 0 to 3.

10. The process of claim 9, wherein the intermetallic alloy coating primarily comprises a member selected from the group consisting of Fe₃Al, FeAl, Fe_{w}Al where w is ⅘ to 4, and combinations thereof.

11. The process of claim 9, wherein the intermetallic alloy coating primarily comprises a member selected from the group consisting of Ni₃Al, NiAl, Ni_{w}Al where w is ⅔ to 4, and combinations thereof.

12. The process of claim 9, wherein the intermetallic alloy coating comprises a member selected from the group consisting of FeCrAl, NiCr, CoCr, and combinations thereof.

13. The process of claim 1, wherein heat is generated when the metal powder reacts with the metal substrate, and said heat promotes formation of the intermetallic alloy coating.

14. The process of claim 1, wherein the injecting the metal powder further includes using a carrier gas to transport the metal powder to the zone.

15. The process of claim 14, further comprising providing a shielding gas volumetrically surrounding the zone sufficient to substantially reduce oxidation.

16. The process of claim 15, wherein at least one of the plasma gas, the carrier gas, and the shielding gas include an inert gas.

17. The process of claim 16, wherein at least one of the plasma gas, the carrier gas, and the shielding gas further includes hydrogen as an oxidation prevention gas.

18. The process of claim 1, wherein the metal substrate is heated to a temperature sufficient to form a thin molten layer on the surface of the metal substrate during the injecting the metal powder.

19. An intermetallic coating for a metal substrate formed by a process comprising:
(a) introducing a gas between an electrode and the metal substrate, wherein the electrode and the metal substrate are connected through a DC power source;
(b) establishing a voltage between the electrode and the metal substrate sufficient to create from the gas a plasma arc extending between the electrode and the metal substrate, so that said plasma arc heats a zone of the metal substrate; and
(c) injecting a metal powder into the plasma arc adjacent to the zone, so that the metal powder is heated sufficiently to cause it to react with the metal substrate and thereby create an intermetallic alloy coating in the zone,
wherein the intermetallic alloy coating exhibits a substantially metallurgical bond with the metal substrate, and the intermetallic alloy coating is substantially free from porosities.

20. The intermetallic coating of claim 19, wherein the metal substrate comprises iron or nickel.

21. The intermetallic coating of claim 19, wherein the intermetallic alloy coating comprises M_{w}CrₓAl_{y}X_{z}, where M is Fe, Ni, or Co; X is a transition metal; w is from 1 to 5; x is 0 to 5; y is 0 or 1 wherein both x and y cannot be zero; and z is an integer from 0 to 3.

22. The intermetallic coating of claim 21, wherein the intermetallic alloy coating primarily comprises a member selected from the group consisting of Fe₃Al, FeAl, Fe_{w}Al where w is ⅘ to 4, Ni₃Al, NiAl, Ni_{w}Al where w is ⅔ to 4, FeCrAl, NiCr, CoCr, and combinations thereof.

23. The intermetallic coating of claim 18, wherein the intermetallic coating has a thickness of from about 0.05 mm to about 5 mm.
